(19) United States
(12) Patent Application Publication
(10) Pub. No.: US 2013/0087245 A1
(43) Pub. Date: Apr. 11, 2013

(54) COOLING SYSTEM FILLING AIR

(71) Applicants: David E. Svacha, Waterford, MI (US); Francis P. Hutchins, JR., Hadley, MI (US)

(72) Inventors: David E. Svacha, Waterford, MI (US); Francis P. Hutchins, JR., Hadley, MI (US)

(73) Assignee: CHRYSLER GROUP LLC, Auburn Hills, MI (US)

(21) Appl. No.: 13/268,463

(22) Filed: Oct. 7, 2011

(51) Int. Cl. B65B 3/06; F01P 11/00; B67C 11/00

(52) U.S. Cl. 141/331; 141/383

(57) ABSTRACT

A coolant filling assembly including a coolant bottle having a threaded neck, and a coolant filling aid having a cap that threadingly couples to the threaded neck of the coolant bottle. The coolant filling aid includes a conical body having a seal assembly at an end thereof. The cap is positioned between the conical body and the seal assembly, and the seal assembly sealingly engages an inner surface of the threaded neck of the coolant bottle.

### FIELD

The present disclosure relates to a cooling system filling aid for a vehicle.

### BACKGROUND

Engine liquid cooling systems of most new vehicles are quickly filled at the manufacturing facility by special power equipment to supply measured quantities of solutions of ethylene glycol antifreeze, corrosion inhibitors, and water. Such coolant solutions provide full engine and coolant system protection over a wide range of temperatures experienced by the vehicle from very cold to extremely hot weather operations. The rust preventing and lubricating agents of the solution further protect the radiator, water pump and other components in the coolant system.

Since coolant solutions have a finite life, changing the engine coolant in field service is necessary and is generally done by manually adding fluid directly into the system. Such field service, in contrast to a powered factory fill, is usually a lengthy and inefficient process. Moreover, if close attention is not observed, such field service may result in an incomplete filling of the cooling system.

When adding coolant solution to a closed engine cooling system in the field, the pressure cap is removed from the filler neck of the radiator or from the deareation chamber of an auxiliary coolant container or bottle and replacement coolant is poured into the filler neck thereof. The space in the radiator or bottle immediately below the filler neck may fill up quickly as the added volume of coolant slowly flows into the rest of the cooling system. When the observed level in the radiator or deareation chamber finally recedes to an appropriate level, additional volumes of coolant are added with additional service time spent waiting for the system to be appropriately filled. This slow field filling process is even more inefficient when the entire system is drained and replaced by a new solution. In some vehicles, particularly those with stylized low hood lines and where there is minimized space to locate coolant bottles at elevated positions, such field service may take several hours for a complete fill with replacement coolant. Thus there remains a need for improvement.

### SUMMARY

The present disclosure provides a filling aid for adding coolant to a coolant bottle having a threaded neck. The filling aid includes a conical body, and a cap portion coupled to the conical body. The cap portion has a threaded portion that corresponds to the threaded neck of the coolant bottle, and the cap portion has a seal assembly extending axially relative to the conical body. The seal assembly sealingly engages an inner surface of the threaded neck of the coolant bottle.

The present disclosure also provides a coolant filling assembly including a coolant bottle having a threaded neck, and a coolant filling aid having a cap that threadingly couples to the threaded neck of the coolant bottle. The coolant filling aid includes a conical body having a seal assembly at an end thereof. The cap is positioned between the conical body and the seal assembly, and the seal assembly sealingly engages an inner surface of the threaded neck of the coolant bottle.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### BRIEF DESCRIPTION OF THE DRAWINGS

FIG. 1 is a schematic representation of an engine including a coolant system;

FIG. 2 is a top-perspective view of a filling aid according to the present disclosure;

FIG. 3 is a partial cross-sectional view taken along line 3-3 of a filling aid according to the present disclosure coupled to a coolant bottle including a threaded neck; and

FIG. 4 is a cross-sectional view of a filling aid according to the present disclosure coupled to a coolant bottle.

### DETAILED DESCRIPTION

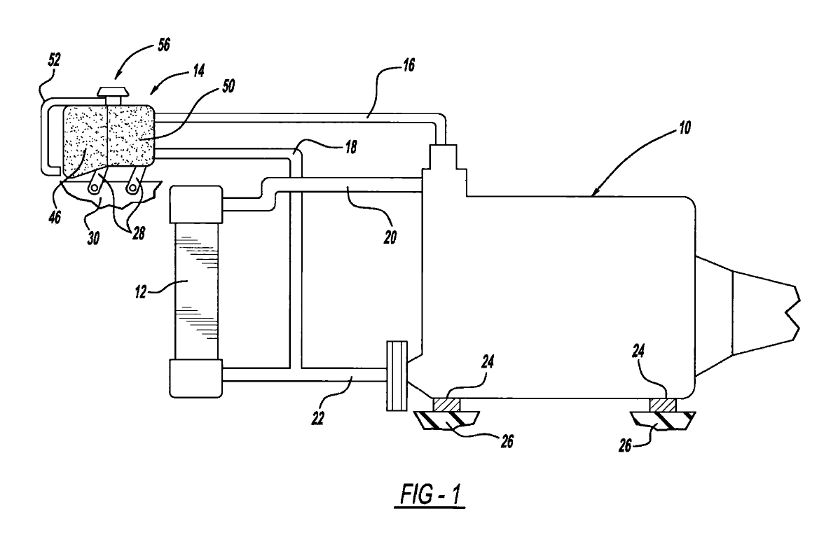

FIG. 1 schematically illustrates a liquid cooled internal combustion engine 10 having a radiator 12 and a liquid coolant deaeration and overflow bottle 14. Engine 10, radiator 12, and overflow coolant bottle 14 are in fluid communication with each other via fluid lines 16, 18, 20, and 22. Engine 10 is supported with an engine compartment of a vehicle by resilient mounts 24 secured on a vehicle frame 26, while coolant bottle 14 is mounted by brackets 28 to a fixed vehicle structure 30. As illustrated in FIG. 1, coolant bottle 14 is only slightly elevated relative to engine 10 and radiator 12.

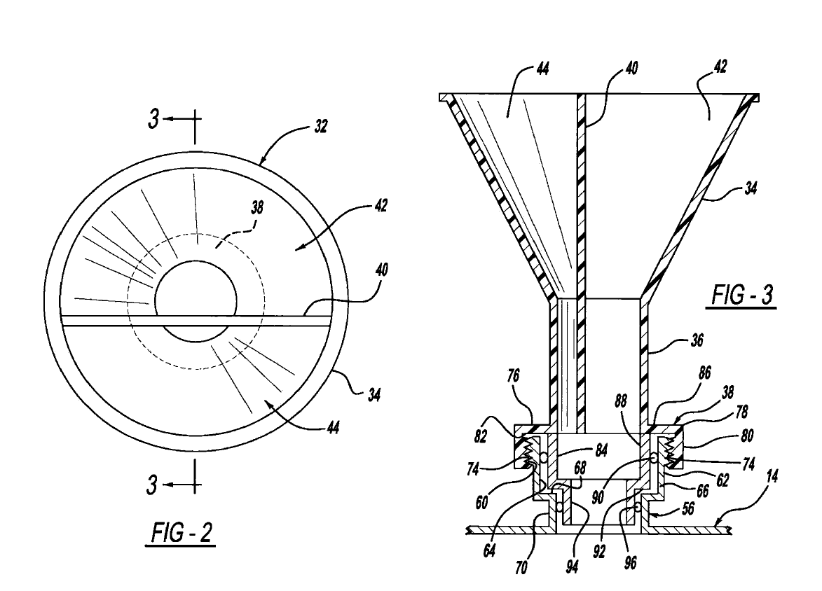

Since coolant fill equipment powered by pressure or activated by another power source is generally not available or used by vehicle owners, service garages, or even repair shops, the present disclosure provides an economical and highly efficient filling aid 32 that is readily affordable and which can be easily used by service personnel or a person having only ordinary mechanical skill. As best illustrated in FIGS. 2 and 3, filling aid 32 has a generally funnel-like configuration with an upper conical body 34 integral or unitary with a cylindrical neck 36. Cylindrical neck 36 terminates at a cap 38 integral or unitary with neck 36 that couples filling aid 32 to coolant bottle 14. Positioned within filling aid 32 is a dividing wall 40. Dividing wall 40 separates conical body 34 and cylindrical neck 36 into a coolant fill section 42 and an air escape section 44.

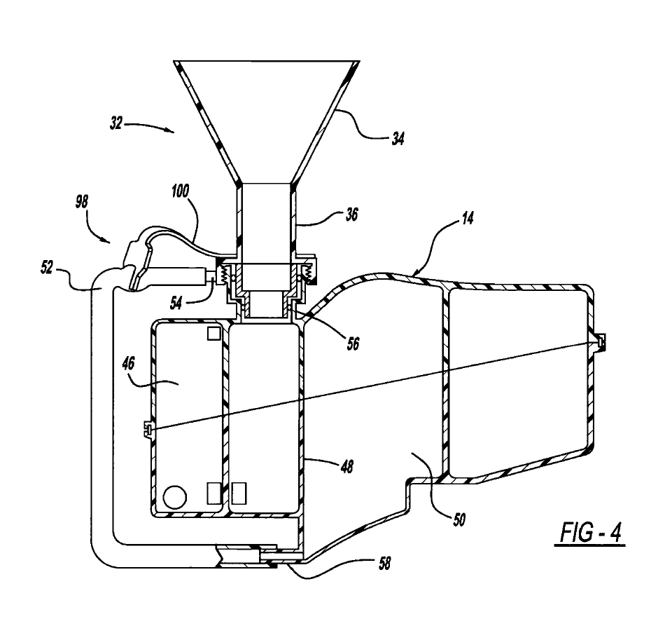

As best illustrated in FIG. 4, coolant bottle 14 includes a deaeration chamber 46 fluidly separated by a pressure wall 48 from an overflow chamber 50. These chambers are arranged in a lateral side-by-side configuration, but are in fluid communication to one another by a flexible hose 52 that extends from a radial overflow nipple 54 extending externally of the bottle 14 from a filler neck 56 to an inlet nipple 58 to overflow chamber 50. A fluid seal between filling aid 32 and bottle 14 is positioned above the overflow nipple 54.

When engine 10 is at ambient temperature, coolant will normally be present only in the deaeration chamber 46. Overflow chamber 50 is designed to normally be empty and is used only to recover coolant at higher temperatures caused by expansion of the liquid with increased temperature. Coolant bottle 14, including deaeration chamber 46, pressure wall 48, and overflow chamber 50 may be formed of a plastic material that is resistant to degradation from the coolant used therein.

As best shown in FIGS. 3 and 4, filler neck 56 includes a threaded portion 60 about an outer surface 62 thereof. An inner surface 64 includes a first leg 66 extending axially that terminates at a shoulder 68 that extends radially inwardly from first leg 66. Inner surface 64 also includes, extending axially from shoulder 68, a second leg 70. Similar to deaeration chamber 46, pressure wall 48, and overflow chamber 50, filler neck 56 may also be formed from the plastic material. Filler neck 56 may also be formed from an insert (not shown) that is formed from brass or some other substantially non-reactive metal material.

In accordance with the present disclosure, cap 38 is designed with a thread 74 that corresponds to threaded portion 60 of filler neck 56 so that cap 38 and filling aid 32 may sealingly engage with bottle 14. Cap 38, therefore, includes a skirt 76 that extends radially outward from cylindrical neck 36. At a radially distal end 78 of skirt 76 is positioned an axially extending flange 80 that includes thread 74 on an inner surface 82 thereof. As stated above, thread 74 corresponds to threaded portion 60 of filler neck 56. When filling aid 32 is coupled to filler neck 56, therefore, an air-tight seal is developed between filling aid 32 and filler neck 56.

To further ensure that an air-tight seal is developed between filling aid 32 and filler neck 56, cap 38 includes a seal assembly 84. Seal assembly 84 is positioned at a proximal end 86 of skirt 76 and extends axially into filler neck 56. Seal assembly 84 is shaped to correspond to inner surface 64 of filler neck 56. In this regard, seal assembly 84 includes a first sealing leg 88 having a first sealing member 90 positioned thereon. First sealing member 90 seals against first leg 66. Seal assembly 84 also includes an abutment surface 92 that extends radially inwardly from first sealing leg 88 and abuts shoulder 68. A second sealing leg 94 including a second sealing member 96 extends axially from abutment surface 92. Second sealing member 96 seals against second leg 70 of filler neck 56. First and second sealing members 90 and 96 may be annularly shaped, and may be formed from rubber- or polymeric-based materials. First and second sealing members 90 and 96 may be o-rings, or may be lip seals, without limitation.

Filling aid 32 is accordingly fixed to bottle 14 through threaded cap 38 and threaded filler neck 56. After filling aid 32 is coupled to bottle 14, a clip 98 (FIG. 4) is used to close the overflow hose 52 that runs between chambers 46 and 50 of bottle 14. Clip 98 may be formed of a plastic material, and may be coupled to filling aid 32 through use of a strap 100. Then, coolant may be poured into coolant fill section 42 of conical body 34 to begin the operation of completely filling the cooling system of engine 10. Due to the air-tight seal between filling aid 32 and bottle 14, the cooling system of engine 10 is subsequently completely filled in a short period of time. After filling the cooling system of engine 10, clip 98 is removed from hose 62, and a fitting (not shown) may be reattached to filler neck 56 of bottle 14 to close and pressure-seal bottle 14.

What is claimed is:

1. A filling aid for adding coolant to a coolant bottle having a threaded neck, comprising:
a conical body; and
a cap portion coupled to the conical body, the cap portion having a threaded portion that corresponds to the threaded neck of the coolant bottle, and the cap portion having a seal assembly extending axially relative to the conical body, the seal assembly sealingly engaging an inner surface of the threaded neck of the coolant bottle.

2. The filling aid of claim 1, wherein the threaded portion extends radially outward relative to the conical body.

3. The filling aid of claim 1, wherein the seal assembly includes a first leg having a first seal positioned thereon, and a second leg having a second seal positioned thereon.

4. The filling aid of claim 3, wherein the first and second seals are o-rings.

5. The filling aid of claim 3, wherein the first and second legs of the seal assembly are positioned to correspond to a contour of the inner surface of the threaded neck of the coolant bottle.

6. The filling aid of claim 1, further comprising a neck portion positioned between the cap portion and the conical body.

7. The filling aid of claim 4, wherein the conical body is separated by a dividing wall into a coolant receiving section and an air-escape section.

6. A coolant filling assembly, comprising:
a coolant bottle having a threaded neck; and
a coolant filling aid having a cap that threadingly couples to the threaded neck of the coolant bottle,
wherein the coolant filling aid includes a conical body having a seal assembly at an end thereof, the cap being positioned between the conical body and the seal assembly, and the seal assembly sealingly engaging an inner surface of the threaded neck of the coolant bottle.

7. The assembly of claim 6, wherein the cap extends radially outward relative to the conical body, and includes a thread that corresponds to a thread of the threaded neck.

8. The assembly of claim 7, wherein the seal assembly extends axially relative to the cap, and includes a first sealing leg having a first seal positioned thereon, and a second sealing leg having a second seal positioned thereon, each of the first and second seals engaging the inner surface of the threaded neck.

9. The assembly of claim 8, wherein the second sealing leg is positioned radially inward relative to the first sealing leg.

10. The assembly of claim 9, wherein the first and second sealing legs are oriented to correspond to a contour of the inner surface of the threaded neck of the coolant bottle.

11. The assembly of claim 6, wherein the conical body is separated by a dividing wall into a coolant receiving section and an air-escape section.

12. The assembly of claim 6, wherein the inner surface of the threaded neck of the coolant bottle includes a first leg and a second leg separated from the first leg by a shoulder, the second leg being positioned radially inward relative to the first leg by the shoulder.

13. The assembly of claim 12, wherein the seal assembly extends axially relative to the cap, and includes a first sealing leg having a first seal positioned thereon, and a second sealing leg having a second seal positioned thereon, the first seal engaging the first leg of the threaded neck, and the second seal engaging the second leg of the threaded neck.
